(19) United States
(12) Patent Application Publication
(10) Pub. No.: US 2026/0049809 A1
(43) Pub. Date: Feb. 19, 2026

(54) Semiconductor-based Strain Sensor

(71) Applicant: TEXAS INSTRUMENTS INCORPORATED, Dallas, TX (US)

(72) Inventors: Tobias Fritz, Mainburg (DE); Quintin Bynum, Mountain View, CA (US); Yogesh Ramadass, San Jose, CA (US); Anindya Poddar, Sunnyvale, CA (US)

(21) Appl. No.: 18/806,818

(22) Filed: Aug. 16, 2024

(51) Int. Cl. G01B 7/16

(52) U.S. Cl. CPC G01B 7/18

(57) ABSTRACT

A packaged integrated circuit includes a first layer having opposing first and second surfaces, first pads on the first surface, second pads on the second surface, and metal interconnects electrically coupled between the first and second pads. A semiconductor die has opposing first and second sides. The first side of the semiconductor die is mounted on the second surface of the first layer. The first side of the semiconductor die has metal interconnects coupled to the second pads. An enclosure is on the second surface of the first layer. The enclosure wraps around at least part of the semiconductor die. The enclosure has an opening through which at least part of the second side of the semiconductor die is exposed.

### BACKGROUND

A strain gauge is a device that measures the amount of deformation (strain) of an object. A strain gauge may operate based on the principle that electrical resistance of a material within the strain gauge changes as the material is stretched or compressed.

### SUMMARY

In an example, a packaged integrated circuit includes a first layer (e.g., a carrier layer) having opposing first and second surfaces, first pads on the first surface, second pads on the second surface, and metal interconnects electrically coupled between the first and second pad. A semiconductor die has opposing first and second sides. The first side of the semiconductor die is mounted on the second surface of the first layer. The first side of the semiconductor die has metal interconnects coupled to the second pads. An enclosure is on the second surface of the first layer. The enclosure wraps around at least part of the semiconductor die. The enclosure has an opening through which at least part of the second side of the semiconductor die is exposed.

In another example, an apparatus includes a packaged integrated circuit includes a first layer having opposing first and second surfaces, first pads on the first surface, second pads on the second surface, and metal interconnects electrically coupled between the first and second pads. The first layer includes a first material having a Young's modulus in the range of, for example, 10 kPA to 3 GPa. A semiconductor die has opposing first and second sides and has opposing third and fourth sides. The first side of the semiconductor die mounted on the second surface of the first layer. The first side has metal interconnects coupled to the second pads. An enclosure is on the second surface of the first layer. The enclosure wraps around and is spaced from the third and fourth sides of the semiconductor die. The enclosure includes a second material having a low Young's modulus in the range of 10 kPA to 3 GPA.

A strain sensor includes a first layer having opposing first and second surfaces, first pads on the first surface, second pads on the second surface, and metal interconnects electrically coupled between the first and second pads. A semiconductor die has opposing first and second surfaces. The first surface of the semiconductor die is mounted on the second surface of the first layer. The first surface of the semiconductor die has metal interconnects coupled to the second pads and has sensing circuitry configured to generate a signal through at least one of the third pads. The signal is indicative of strain sensed by the semiconductor die. An enclosure is on the second surface of the first layer. The enclosure wraps around at least part of the semiconductor die. The enclosure has an opening through which the second surface of the semiconductor die is exposed.

### BRIEF DESCRIPTION OF THE DRAWINGS

FIG. 1 is a diagram of a strain sensor including a semiconductor die, in some examples.

FIG. 2 is a diagram of a strain sensor including a semiconductor die, in some examples.

FIG. 3 is a cross-sectional view of the strain sensors of FIGS. 1 and 2, in some examples.

FIGS. 4-6 are cross-sectional views of the strain sensors of FIGS. 1 and 2 being attached to a member to sense the member's strain, in some examples.

FIGS. 7 and 8 are diagrams of a strain sensor having a metal ring, in some examples.

### DETAILED DESCRIPTION

The same reference numbers or other reference designators are used in the drawings to designate the same or similar (either by function and/or structure) features.

A strain gauge can stretch or compress in response to the stretching or compression of a member to which the strain gauge is attached. The object may be a load cell, a shaft, or other object. Thicker strain gauges are less responsive to deformations of the member and thus less sensitive. Thicker strain gauges may have gaps or uneven contact between the strain gauge and the member thereby compromising the accuracy of the strain measurements. For a semiconductor-based strain gauge, relatively stiff packaging materials around the semiconductor die may also compromise the strain measurements and create drift and hysteresis in the strain measurements. Further, thicker strain gauges may a have higher mass and a greater inertia thereby resulting in a slower response time to changes in mechanical load. The strain gauges described herein are semiconductor-based strain gauges in which the packaging material of the semiconductor die is relatively flexible and thin, and can addressing the problems described above.

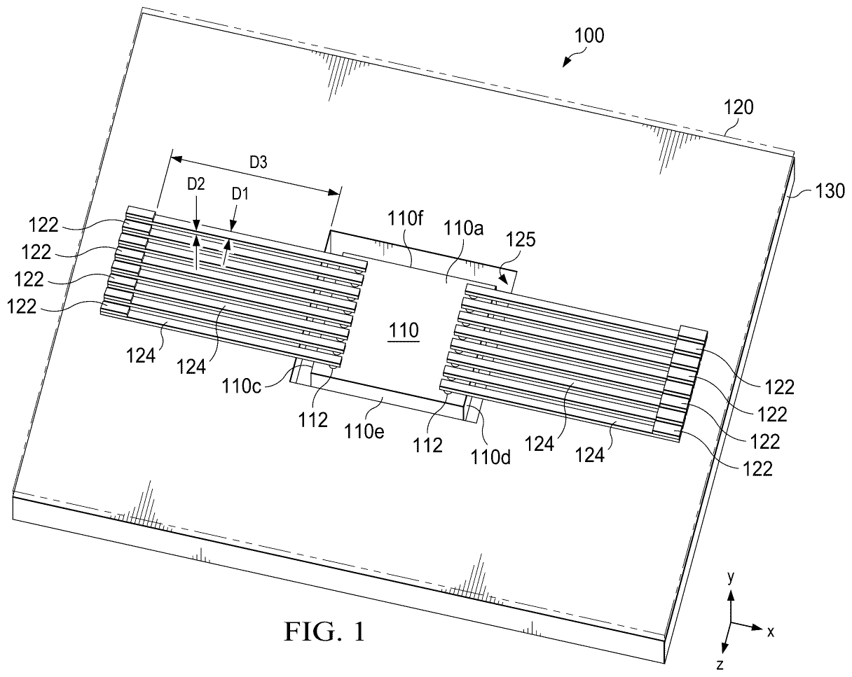

FIG. 1 is a diagram of a strain sensor 100 (e.g., a strain gauge) including a semiconductor die 110, a carrier layer 120, and an enclosure 130. In one example, carrier layer 120 and enclosure 130 are the same material. In an example, carrier layer 120 (also called a first layer) and enclosure 130 include a flexible insulating material, such as polyimide, polyester, glass-reinforced epoxy laminate, silicone, silicon gel, etc. In another example, carrier layer 120 and enclosure 130 are different materials. Semiconductor die 110 is attached to a surface of carrier layer 120. Enclosure 130 has an opening 125 in which the semiconductor die 110 resides. First layer has pads 122 and 112 and metal interconnects 124 coupled to each corresponding pad 112 and 112. Pads 122 provide electrical connections to semiconductor die 110. Semiconductor die 110 includes sensing circuitry (not shown in FIG. 1, but shown in other figures). The sensing circuitry is configured to produce an electrical signal based on the strain imposed on the semiconductor die 110 when strain sensor 100 is attached to a member. Metal interconnects 124 can act as flexible feather to allow the stretching/compressing of the strain sensor.

Semiconductor die 110 has a side 110a to which pads 112 are electrically coupled. The opposing side of semiconductor die 110 is not shown in FIG. 1 but is shown in other figures. Semiconductor die 110 also has opposing sides 110c and 110d and opposing sides 110e and 110f. Sides 110c, 110d, 110e, and 110f are orthogonal to side 110a. Side 110a (and its opposing side viewable in other figures) are referred to as lateral sides. Sides 110c-110f, orthogonal to side 110a, are referred to as vertical sides. Lateral side 110a can be covered and protected by carrier layer 120

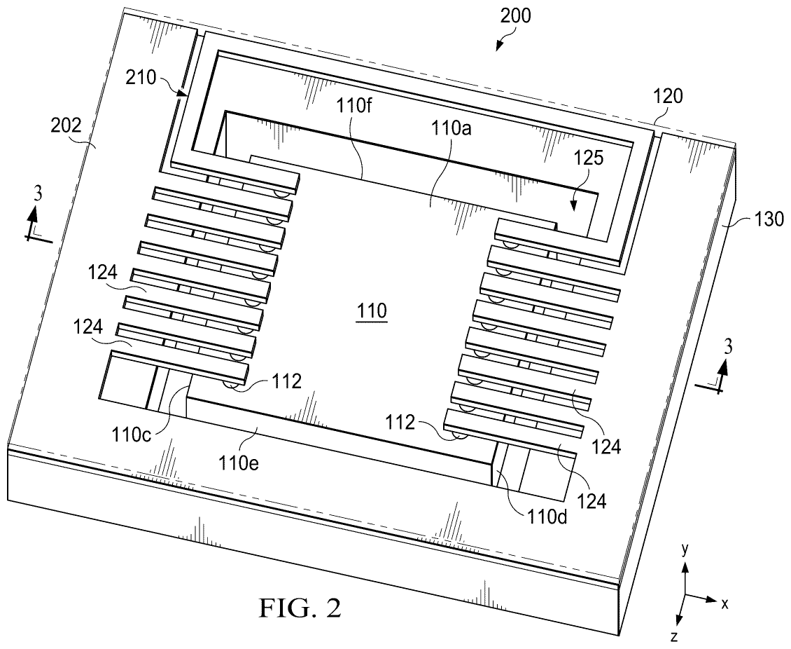

FIG. 2 is a diagram of a strain sensor 200. Strain sensor 200 has similar components as strain sensor 100 of FIG. 1. In addition, strain sensor 200 has a metal layer 202 on enclosure 130. Metal layer 202 includes metal interconnects 124 and a radio frequency (RF) antenna 210. The sensing circuitry (described below) produces an electrical signal based on the strain imposed on the semiconductor die 110, and transmits a signal indicative of the strain through RF antenna 210.

In some examples, semiconductor die 110 has a stiffness that is greater than the stiffness of carrier layer 120 and enclosure 130. For example, semiconductor die 110 may have a Young's modulus value in the range of 50 to 200 giga-Pascals (GPa), while carrier layer 120 and enclosure 130 may have Young's modulus values in the range of 10 kPa to 3 GPa. The sensitivity to strain of strain sensors 100, 200 is relatively high at least in part because carrier layer 120 and enclosure 130 have substantially lower Young's modulus values than semiconductor die. Further, metal interconnects 124 are relatively long, and their dimensions (e.g., width and thickness) are configured to prevent, or at least reduce, the transmission of external mechanical perturbations from pads 122 to semiconductor die 110. FIG. 1 illustrates the cross-sectional dimensions D1 and D2 and a length D3 of a metal interconnect 124. In one example, D1 is 0.3 mm, D2 is 0.2 mm, and D3 is 2 mm.

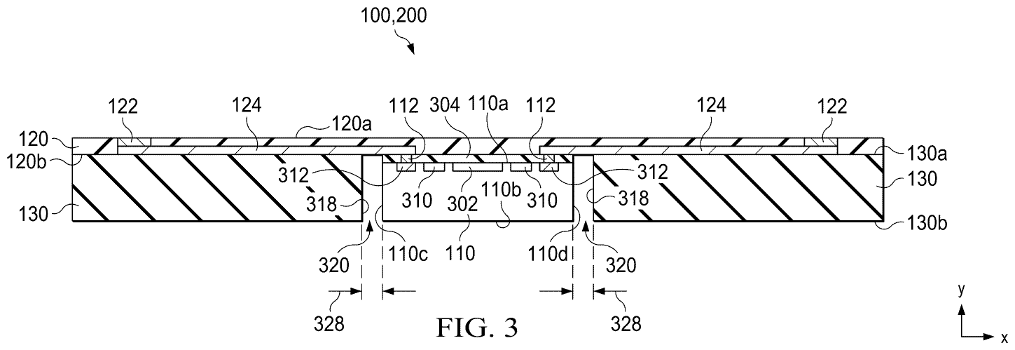

FIG. 3 is a cross-sectional view of strain sensor 100 or 200. Carrier layer 120 has opposing surfaces 120a and 120b. Pads 122 are on surface 120a and pads 112 are on second surface 120b. Metal interconnects 124 electrically couple pads 122 to pads 112. Semiconductor die 110 has opposing sides 110a and 110b. Semiconductor die 110 also has the opposing vertical sides 110c and 110d orthogonal to lateral sides 110a and 110b. Opposing vertical sides 110e and 110f are not viewable in FIG. 3. Side 110a of semiconductor die 110 is mounted on surface 120b of carrier layer 120. A dielectric material 304 (e.g., silicon dioxide) may be included between surface 120b of carrier layer 120 and lateral side 110a of semiconductor die 110 to act as a buffer layer or a protection layer to protect the active area (e.g., sensor area) of semiconductor die 110. Lateral side 110a of semiconductor die 110 has metal interconnects 312 (e.g., pads, solder bumps, metal pillars, etc.) which electrically couple to pads 112.

Semiconductor die 110 includes a sensing area 302 and sensing circuitry 310 on side 110a. Sensing circuitry 310 may include any one or more of an amplifier, a filter, an analog-to-digital converter, etc. Sensing area 302 may stretch or compress in accordance with the strain to which the strain sensor 100, 200 is exposed. The change in resistance of sensing area 302 is a function of the amount of strain detected by the strain sensor 100, 200. Sensing circuitry 310 determines the change in resistance of sensing area to produce a signal (e.g., a digital signal) through one or more of metal interconnects 312 indicative of the sensed strain.

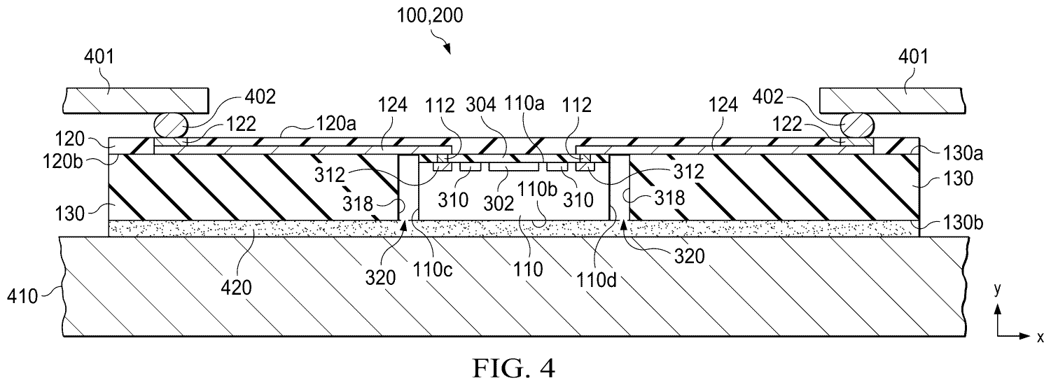

Enclosure 130 has opposing surfaces 130a and 130b. Enclosure 130 is formed on, or otherwise mounted to, the surface 120b of carrier layer 120. Surface 130a of enclosure 130 is adjacent surface 120b of carrier layer 120. Enclosure 130 wraps around at least part of semiconductor die 110. In the example of FIG. 3, enclosure wraps around the vertical sides 110c-110e of semiconductor die 100. Semiconductor die 110 may extend through the opening 125 (FIGS. 1 and 2) in enclosure 130. In some examples, at least part of lateral side 110b is exposed through the opening 125. In some examples, as shown in FIGS. 4-7, the exposed part of lateral side 110b may be attached to a member. Strain sensor 100, 200 senses the strain experienced by the member to which the strain sensor is attached.

In the example of FIG. 3, a spacing 320 separates sides 318 of enclosure 130 from vertical sides 110c and 110d of semiconductor die 110. In some examples, enclosure 130 is spaced from all of vertical sides 110c-110f of semiconductor die 110. In one example, the width 328 of the spacing 320 may be in the range of 0.02 mm to 0.1 mm. The spacing 320 can provide mechanical decoupling (or reduced mechanical coupling) between semiconductor die 110 and enclosure 130 to allow the stretching/compressing of the strain sensor. In some examples, spacing 320 can be filled with a gas, such as nitrogen, helium, air, or other suitable gases. In some examples, spacing 320 can be filled with a solid/liquid flexible filler material to protect the edges of semiconductor die 110 (e.g., from corrosion). The filler material is flexible to facilitate the stretching/compressing of the strain sensor. In some examples, the flexible filler material can include a silicone gel. Silicone gel may have a Young's modulus value in the range of 40 kPa to 200 kPa. In the example of FIG. 3 and the examples of FIGS. 4-8 described below, the strain sensor does not have any mold compound to avoid unduly stiffening the strain gauge.

FIG. 4 is a cross-sectional diagram of strain sensor 100, 200 mounted to a member 410 in an example. Member 410 may include a load cell, a shaft, or other object which may experience strain to be measured by strain sensor 100, 200. In the example of FIG. 4, an adhesive 420 attaches enclosure 130 and semiconductor die 110 to member 410. The adhesive is any suitable adhesive such as a strain gauge adhesive or an epoxy-based adhesive (e.g., fiber reinforced) to increase stiffness, so that the adhesive can transmit the stress from the member to the strain gauge without absorbing the stress (or with the absorption reduced). The adhesive 130 is between surface 130b of enclosure 130 and member 410 and between side 110b of semiconductor die 110 and member 410 to also seal and protect semiconductor die 110.

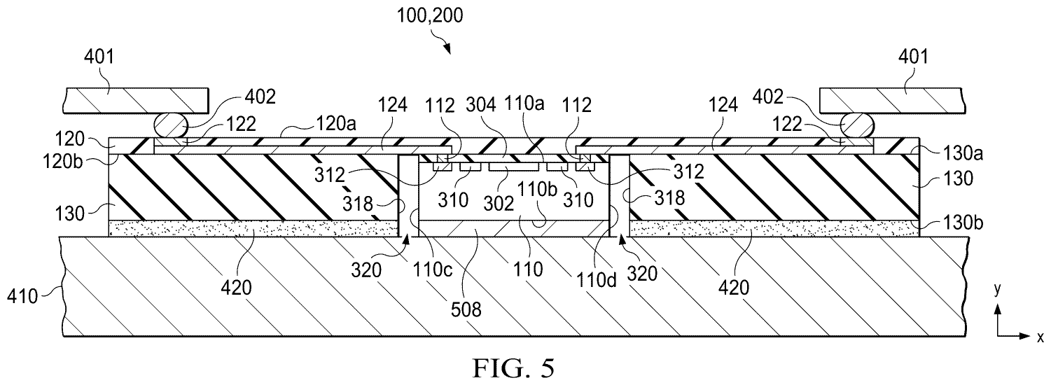

FIG. 5 is a cross-sectional diagram of strain sensor 100, 200 mounted to member 410 in another example. In the example of FIG. 5, adhesive 420 attaches enclosure 130 to member 410 and solder 508 attaches semiconductor die 110 to member 410. The adhesive 420 is between surface 130b of enclosure 130 and member 410, and a metal layer 508 is between side 110b of semiconductor die 110 and member 410. Metal layer 508 can include, for example, a solder layer, sintered metal layer, a reactive multi-layer system (RMS), a metal alloy such as a nickel-aluminum alloy, etc. In some examples, the lateral side 110b may include a backside metallization layer. Metal layer 508 can form a mechanically stronger bond with the member and provide improved stiffness, which can facilitate stress transfer from the member to the stress gauge.

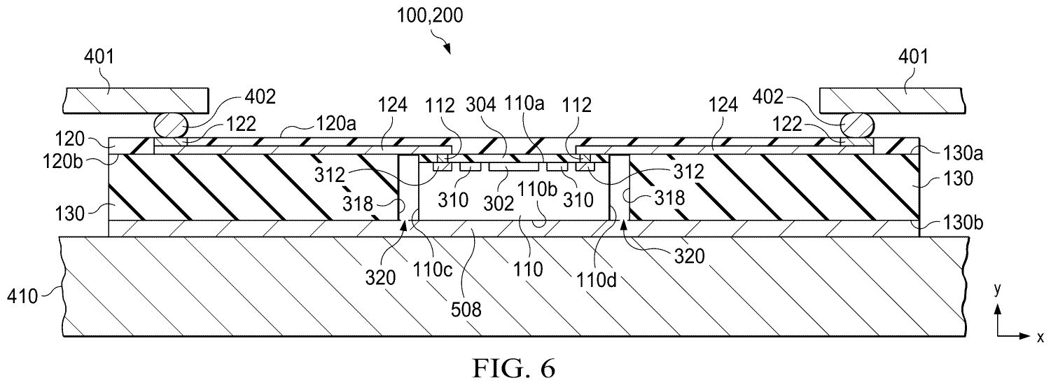

FIG. 6 is a cross-sectional diagram of strain sensor 100, 200 mounted to member 410 in yet another example. In the example of FIG. 6, metal layer 508 attaches enclosure 130 and semiconductor die 110 to member 410. Metal layer 508 is between surface 130b of enclosure 130 and member 410 and between lateral side 110b of semiconductor die 110 and member 410.

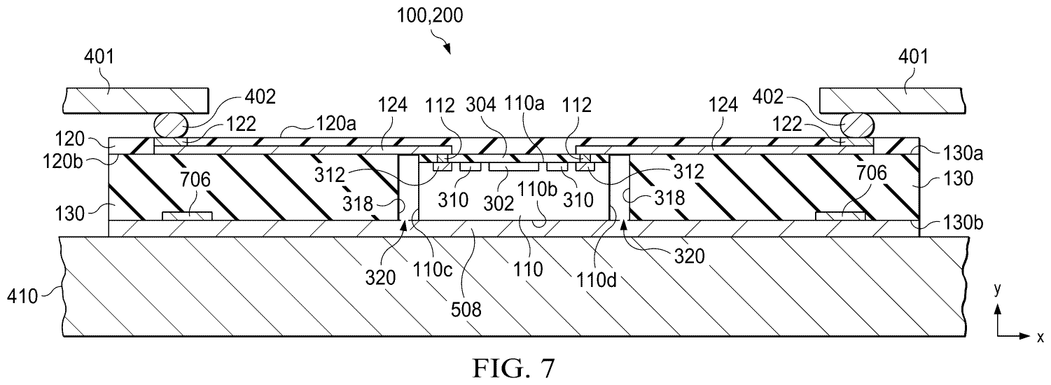

FIG. 7 is a cross-sectional diagram of strain sensor 100, 200 similar that of FIG. 6. The strain sensor 100, 200 of FIG. 7 includes a metal ring 706 (e.g., aluminum, copper) on the surface 130b of enclosure 130. In one example, metal ring 706 is around the semiconductor die 110. Metal ring 706 is at the interface between surface 130b of enclosure 130 and solder 508 (or adhesive 420 as in the example of FIGS. 4 and 5). Metal ring 706 seals the interface from external contaminants intruding into the area in which semiconductor die 110 is located. In some examples, metal ring 706 can also provide electrical connection to ground.

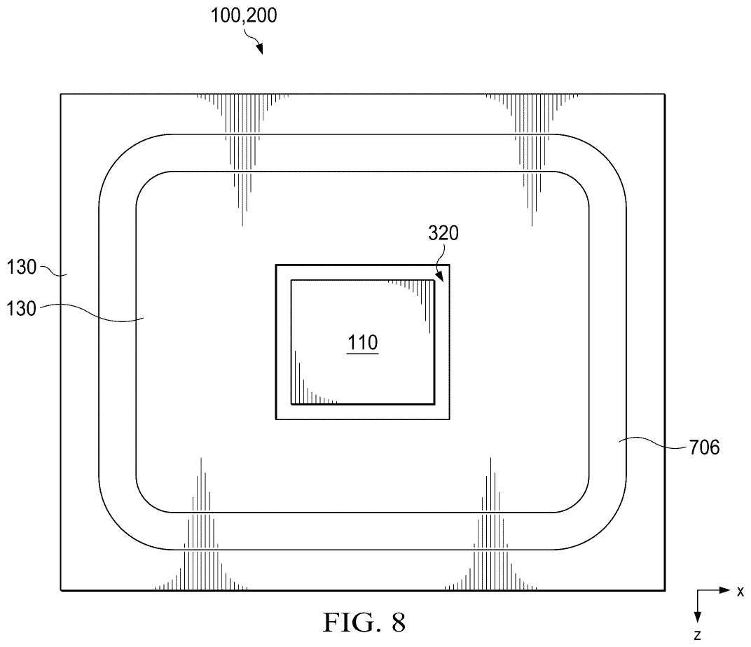

FIG. 8 is top view of strain sensor 100, 200 of FIG. 7 illustrating metal ring 706 surrounding semiconductor die 110. The shape of metal ring 706 can be square with rounded corners (as in FIG. 8) or square with right-angle corners, circular, or any other suitable shape.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

In this description, unless otherwise stated, “about,” “approximately” or “substantially” preceding a parameter means being within +/-10 percent of that parameter or, if the parameter is zero, a reasonable range of values around zero.

Modifications are possible in the described examples, and other examples are possible, within the scope of the claims.

What is claimed is:

1. A packaged integrated circuit (IC) comprising:
a first layer having opposing first and second surfaces, first pads on the first surface, second pads on the second surface, and metal interconnects electrically coupled between the first and second pads;
a semiconductor die having opposing first and second sides, the first side of the semiconductor die mounted on the second surface of the first layer, the first side of the semiconductor die having metal interconnects coupled to the second pads; and
an enclosure on the second surface of the first layer, the enclosure wraps around at least part of the semiconductor die, the enclosure having an opening through which at least part of the second side of the semiconductor die is exposed.

2. The packaged IC of claim 1, wherein the semiconductor die has a first Young's modulus value, the enclosure has a second Young's modulus value, and the first Young's modulus value is at least ten times larger than the second Young's modulus value.

3. The packaged IC of claim 1, wherein the semiconductor die has a first Young's modulus value in a range of 50 giga-Pascals (GPa) to 200 GPa.

4. The packaged IC of claim 1, wherein the semiconductor die has a first Young's modulus value in a range of 50 GPa to 200 GPa, and the enclosure has a second Young's modulus value in a range of 10 Pascals (kPa) to 3 GPa.

5. The packaged IC of claim 1, further comprising a dielectric material between the second surface of the first layer and the semiconductor die.

6. The packaged IC of claim 1, wherein the semiconductor die includes sensing circuitry on the first side of the semiconductor die.

7. The packaged IC of claim 1, wherein the semiconductor die has third and fourth sides orthogonal to the first and second sides, and the third and fourth sides are spaced from the enclosure.

8. The packaged IC of claim 7, further comprising a filler material between the third and fourth sides of the semiconductor die and the enclosure.

9. The packaged IC of claim 8, wherein a stiffness of the semiconductor die is at least ten times a stiffness of the filler material.

10. The packaged IC of claim 9, wherein:
the first layer comprises at least one of FR4, polymide, or silicone;
the enclosure comprises at least one of FR4, polymide, or silocone; and
the filler material comprises at least one of FR4, polymide, or silicone.

11. The packaged IC of claim 1, wherein the semiconductor die includes a metal layer on the second side, and the metal layer is exposed through the opening.

12. The packaged IC of claim 1, further comprising a metal layer covering the enclosure and the at least part of the second side of the semiconductor die that is exposed.

13. The packaged IC of claim 1, wherein the enclosure comprises opposing first and second surfaces, the first surface of the enclosure adjacent the second surface of the first layer, and the packaged IC further comprising a metal ring on the second surface of the enclosure, the metal ring around the semiconductor die.

14. An apparatus comprising:
a packaged integrated circuit (IC) including:
a first layer having opposing first and second surfaces, first pads on the first surface, second pads on the second surface, and metal interconnects electrically coupled between the first and second pads, the first layer comprising a first material having a Young's modulus in a range of 10 kilo-Pascals (kPA) to 3 giga-Pascals (GPa);
a semiconductor die having opposing first and second sides and having opposing third and fourth sides, the first side of the semiconductor die mounted on the second surface of the first layer, the first side having metal interconnects coupled to the second pads; and
an enclosure on the second surface of the first layer, the enclosure wraps around and is spaced from the third and fourth sides of the semiconductor die, the enclosure comprising a second material having a Young's modulus in a range of 10 kPa to 3 GPa.

15. The apparatus of claim 14, wherein the first layer comprises at least one of polyimide, polyester, glass-reinforced epoxy laminate, silicone, or silicon gel.

16. The apparatus of claim 14, wherein the enclosure has an opening through which the second side of the semiconductor die is exposed.

17. The apparatus of claim 14, wherein the semiconductor die includes sensing circuitry on the first side of the semiconductor die.

18. The apparatus of claim 14, further comprising a filler material between the third side of the semiconductor die and the enclosure and between the fourth side of the semiconductor die and the enclosure.

19. The apparatus of claim 18, wherein the filler material comprises a silicone gel.

20. The apparatus of claim 14, further comprising a member and adhesive attaching the member to the second side of the semiconductor die.

21. The apparatus of claim 14, further comprising a member and a metallic material attaching the member to the second side of the semiconductor die.

22. A strain sensor, comprising:
a first layer having opposing first and second surfaces, first pads on the first surface, second pads on the second surface, and metal interconnects electrically coupled between the first and second pads;
a semiconductor die having opposing first and second surfaces, the first surface of the semiconductor die mounted on the second surface of the first layer, the first surface of the semiconductor die having metal interconnects coupled to the second pads and having sensing circuitry configured to generate a signal through at least one of the metal interconnects, the signal indicative of strain sensed by the semiconductor die; and
an enclosure on the second surface of the first layer, the enclosure wraps around at least part of the semiconductor die, the enclosure having an opening through which the second surface of the semiconductor die is exposed.

23. The strain sensor of claim 22, wherein the semiconductor die has a first Young's modulus value, the enclosure has a second Young's modulus value, and the first Young's modulus value is at least ten times larger than the second Young's modulus value.

24. The strain sensor of claim 22, wherein the enclosure is spaced from the semiconductor die.

25. The strain sensor of claim 24, further comprising silicone between the enclosure and the semiconductor die.

26. The strain sensor of claim 24, further comprising a gas between the enclosure and the semiconductor die, the gas including at least one of nitrogen or hydrogen.
